(19) United States
(12) Patent Application Publication
(10) Pub. No.: US 2026/0343623 A1
(43) Pub. Date: Oct. 29, 2026

(54) COMMUNICATION APPARATUS AND CONTROL METHOD

(71) Applicant: CANON KABUSHIKI KAISHA, Tokyo (JP)

(72) Inventor: DAISUKE KAWAKAMI, Tokyo (JP)

(21) Appl. No.: 19/655,015

(22) Filed: Apr. 22, 2026

(30) Foreign Application Priority Data
Apr. 24, 2025 (JP) 2025-072618

(51) Int. Cl. H04W 74/0833; H04B 17/309; H04B 17/318; H04W 74/00; H04W 84/12

(52) U.S. Cl. CPC H04W 74/0833; H04B 17/318; H04B 17/346; H04W 74/002; H04W 84/12

(57) ABSTRACT

A control method of a communication apparatus configured to perform communication compliant with an IEEE 802.11 series standard includes, externally signaling information indicating whether transmission of an ICF is permitted to be omitted when channel access is performed via an NPCA primary channel to be used in a case where a BSS primary channel is unavailable, and after the signaling, communicating a frame different from the ICF with another communication apparatus via the NPCA primary channel.

### BACKGROUND

### Field of the Technology

The present disclosure relates to a communication apparatus and a control method.

### Description of the Related Art

Wireless local area networks (LANs) typified by the Institute of Electrical and Electronics Engineers (IEEE) 802.11 series standards are currently in widespread use. The IEEE 802.11 series standards include standards such as IEEE 802.11a/b/g/n/ac/ax/be. For further improvement in communication reliability, the IEEE 802.11bn standard is being developed as a successor to the IEEE 802.11be standard.

The use of a control frame that may be called initial control frame (ICF) is being contemplated for the purpose of triggering communication corresponding to features that may be implemented in the IEEE 802.11bn standard or its subsequent successor standards. The use of a response frame to the ICF, which is a control frame that may be called an initial control response (ICR), is also being contemplated. The task group Task Group bn (TGbn) responsible for developing the technical specifications for the IEEE 802.11bn standard has decided to adopt the conventional Buffer Status Report Poll (BSRP) trigger frame as an ICF frame structure. Moreover, adopting a Multi-Station (Multi-STA) Block Ack (M-BA) frame as an ICR frame structure is being studied.

For the IEEE 802.11bn standard, the following is also being contemplated for situations where the primary channel is busy when a plurality of channels with a frequency bandwidth of 20 MHz is bonded to perform data communication. That is, Non-Primary Channel Access (NPCA), which enables communication using only channels other than the primary channel (e.g., secondary channels), is being contemplated.

For discussions on ICF, ICR, and NPCA, see Alfred Asterjadhi, "TGbn January 2025 Meeting Agenda (IEEE 802.11-24/2074r17)", 2025.

### SUMMARY

The present disclosure is directed to providing a technique for appropriately controlling transmission and reception of initial control frames (ICFs) and initial control responses (ICRs) during Non-Primary Channel Access (NPCA).

According to an aspect of the present disclosure, a communication apparatus is configured to perform communication compliant with an Institute of Electrical and Electronics Engineers (IEEE) 802.11 series standard, and the communication apparatus includes at least one memory that stores a set of instructions, and at least one processor that executes the instructions, the instructions, when executed, causing the communication apparatus to perform operations including externally signaling information indicating whether transmission of an initial control frame (ICF) is permitted to be omitted when channel access is performed via a Non-Primary Channel Access (NPCA) primary channel to be used in a case where a basic service set (BSS) primary channel is unavailable.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of a wireless communication system according to an embodiment.

FIG. 2 is a diagram illustrating a hardware configuration example of a communication apparatus according to the embodiment.

FIG. 3 is a diagram illustrating a functional configuration example of the communication apparatus according to the embodiment.

FIG. 4 is a diagram illustrating a configuration example of an initial control frame (ICF) according to the embodiment.

FIG. 5 is a diagram illustrating a configuration example of a conventional Common Info field.

FIG. 6 is a diagram illustrating an example of association between the values of an ICF Repeat field and communication features according to the embodiment.

FIG. 7 is a diagram illustrating a configuration example of an initial control response (ICR) according to the embodiment.

FIG. 8 is a diagram illustrating a procedure for communication processing when Non-Primary Channel Access (NPCA) is used according to the embodiment.

FIG. 9 is a flowchart illustrating an example of processing for performing NPCA according to the embodiment.

FIG. 10 is a flowchart illustrating an example of processing for performing NPCA according to the embodiment.

FIG. 11 is a diagram illustrating an example of processing for determining whether to continue transmission and reception of ICFs and ICRs according to the embodiment.

### DESCRIPTION OF THE EMBODIMENTS

An embodiment will be described in detail below with reference to the attached drawings. The following embodiment is not intended to limit the content set forth in the claims. While a plurality of features is described in the embodiment, not all of these features are necessarily essential to the present disclosure, and multiple features may be freely combined. In the attached drawings, the same or similar components are denoted by the same reference numerals, and redundant descriptions thereof will be omitted.

### EMBODIMENT

### System Configuration

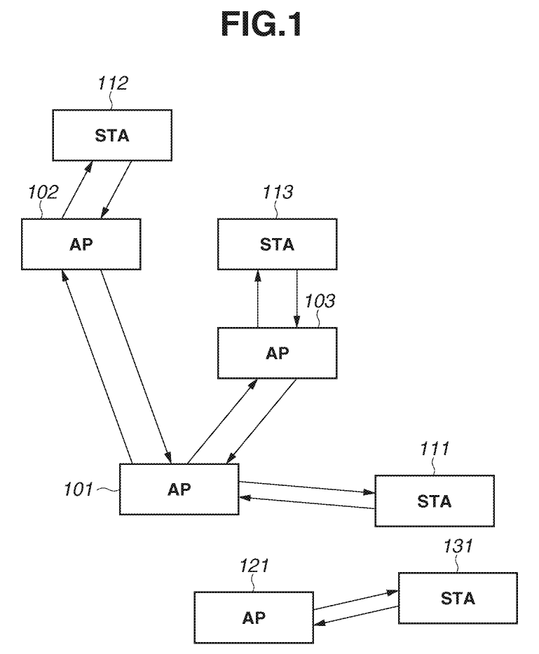

FIG. 1 is a diagram illustrating a configuration example of a wireless communication system according to the present embodiment.

This wireless communication system includes communication apparatuses that perform wireless local area network (LAN) communication compliant with Institute of Electrical and Electronics Engineers (IEEE) 802.11 series standards. FIG. 1 illustrates a state where there are access points (e.g., access point [AP] 101, AP 102, AP 103, and AP 121) and stations (e.g., station [STA] 111, STA 112, STA 113, and STA 131) as communication apparatuses. However, this is merely an example. The APs and/or the STAs may be fewer (for example, a single AP and/or a single STA) or more in number. The APs 101, 102, 103, and 121 will hereinafter be referred to simply as "APs", and the STAs 111, 112, 113, and 131 simply as "STAs", unless distinction is particularly needed. The STAs may be referred to as non-AP STAs.

Examples of the APs include, but are not limited to, wireless LAN routers and personal computers (PCs). Examples of the STAs include, but are not limited to, cameras, tablets, smartphones, PCs, mobile phones, video cameras, and wearable devices such as smartglasses. For example, the STAs may be Internet of Things (IoT) devices such as IoT sensors, smart locks, and smart sensors. Examples of the IoT sensors may include acceleration sensors, optical sensors, and humidity sensors.

The APs and STAs may be information processing apparatuses such as wireless chips that are compliant with the IEEE 802.11bn standard and the like and can transmit and receive Ultra High Reliability (UHR) Physical Layer Convergence Procedure (PLCP) Protocol Data Units (PPDUs). In such a case, hardware circuits in the wireless chips can be configured to perform various controls. A processor such as an application-specific instruction set processor (ASIP), memory, and hardware circuits in a wireless chip may be configured to c perform various types of processing in cooperation. The PPDU is an example of a Physical layer Protocol Data Unit, which is also abbreviated as PPDU.

The designation "UHR" is a provisional one in consideration of the objectives to be achieved by this standard and the characteristic features defined in this standard. That is, when the standardization is completed, a different name may be given to this standard. The same applies to the designation "IEEE 802.11bn", and a different name may be given when the standardization is completed. It should be noted that, with these cases included, this specification and the appended claims are essentially applicable to all successor standards that are successors to the IEEE 802.11be standard.

The APs and the STAs may communicate using wireless signals in frequency bands such as 2.4-, 3.6-, 5-, and 6-GHz bands, as well as what are called millimeter-wave bands, e.g., 45- and 60-GHz bands. The frequency bands to be used by the APs and the STAs are not limited thereto, and may be sub-1-GHz bands and the like, for example. Moreover, the APs and STAs may communicate using frequency channels with bandwidths of 20 MHz, 40 MHz, 80 MHz, 160 MHz, 320 MHz, 540 MHz, 640 MHz, 1080 MHz, and 2160 MHz. The bandwidths to be used by the APs and the STAs are not limited thereto. For example, 240 MHz, 4 MHz, and the like may be used. A 40-MHz frequency channel may be formed by bonding two 20-MHz frequency channels. An 80-MHz frequency channel may be formed by bonding two 40-MHz frequency channels. An 80-MHz frequency channel may also be formed by bonding four 20-MHz frequency channels. Frequency channels such as 160- and 320-MHz frequency channels may be similarly formed by bonding or combining a plurality of channels of frequency bandwidths narrower than the respective bandwidths.

In the present wireless communication system, the AP 101 is connected to the STA 111, for example, and is in a state capable of performing communication. The APs 102, 103, and 121 are respectively connected to the STAs 112, 113, and 131, for example, and are in a state capable of performing communication. Assume that at least the network (e.g., basic service set [BSS]) formed by the AP 101 is different from that formed by the AP 121, but uses the same frequency channel. In other words, from the perspective of the AP 101, the BSS formed by the AP 121 is an overlapping BSS (OBSS).

The APs and STAs according to the present embodiment are configured to be capable of performing communication compliant with the IEEE 802.11bn standard or its successor standards. These standards may implement communications having various features. At least some of the communications are triggered by exchange of a control frame that may be referred to as an initial control frame (ICF) and a response frame to ICF that may be referred to as an initial control response (ICR). ICF and ICR are provisional names, and may be called by other names as the standardization progresses. For example, an ICF may be referred to as a trigger frame. While the names "ICF" and "ICR" are used in the following description, the following description is applicable to a control frame and its response with any names that have the function of triggering communication functions characteristic to the IEEE 802.11bn or its successor standards. Moreover, the following discussion is not limited to the IEEE 802.11bn or its successor standards, but may be applied to any other IEEE 802.11 series standards to which ICF and ICR are applicable. The group of IEEE 802.11 standards to which ICF and ICR according to the present embodiment are applicable may hereinafter be referred to as "IEEE 802.11bn and other standards".

The task group Task Group bn (TGbn) responsible for developing the technical specifications for the IEEE 802.11bn standard has decided to adopt the conventional Buffer Status Report Poll (BSRP) trigger frame as an ICF frame structure. BSRP is a trigger frame in which a Trigger Type field is set to "4". In the ICF, a Guard Interval And Long Training Field (GI And LTF) Type field is set to "3" (binary "11"), a value that is currently unused. This frame format may be referred to as BSRP GI3. The GI And LTF Type field is a field conventionally used to indicate Guard Interval (GI) and Long Training Field (LTF) types (e.g., the length of GI and the number of LTFs). The GI And LTF Type field may be called by other names, such as a GI And High Efficiency (HE)-LTF Type field and a GI And HE/Extremely High Throughput (EHT)/UHR-LTF Type/Transmit Sector (TXS) Mode field. Moreover, adopting a Multi-STA Block Ack (M-BA) frame as an ICR frame structure is being contemplated. The M-BA frame includes a Per Association Identifier (AID) Traffic Identifier (TID) Info subfield. An Ack Type subfield and a TID subfield in this Per AID TID Info field may be used to indicate whether this frame is an ICR or a conventional Ack or BA.

One of the communications triggered by the exchange of an ICF and an ICR is Non-Primary Channel Access (NPCA). Conventionally, communication apparatuses (e.g., APs and STAs) can bond and use a plurality of channels with 20-MHz frequency bandwidths on condition that a specific channel (e.g., a primary channel) with a 20-MHz frequency bandwidth is not being used (i.e., not busy). On the other hand, if the primary channel is busy, the communication apparatuses are unable to use the other channels even when the other channels are idle. By contrast, NPCA is a technique that enables communication using only channels (e.g., secondary channels) other than the primary channel when the primary channel is busy.

As described above, NPCA is characterized by being triggered through exchange of an ICF and an ICR. When NPCA is performed, the ICF and the ICR are therefore always transmitted and received before data communication. Repeating the transmission and reception of ICFs and ICRs during NPCA thus increases communication overhead. Moreover, if an ICF or ICR is missed during NPCA, NPCA-related processing may fail to be appropriately performed.

In view of the foregoing circumstances, in the present embodiment, information indicating whether to transmit and receive ICFs and ICRs before subsequent data communication or to transmit subsequent data frames and trigger frames without the transmission and reception of ICFs and ICRs is added to an ICF and/or an ICR. This enables appropriate transmission and reception of ICFs and ICRs during NPCA and can improve communication efficiency during NPCA.

### Apparatus Configuration

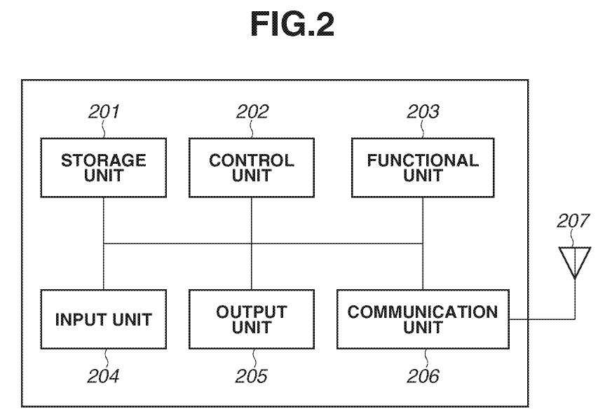

FIG. 2 is a diagram illustrating a hardware configuration example of the communication apparatuses (e.g., APs and STAs) according to the present embodiment. Each communication apparatus includes, as an example of its hardware configuration, a storage unit 201, a control unit 202, a functional unit 203, an input unit 204, an output unit 205, a communication unit 206, and an antenna 207. Note that the hardware configuration illustrated in FIG. 2 is merely an example, and the communication apparatus may include additional components not illustrated in FIG. 2. Some or all of the components illustrated in FIG. 2 may be replaced with other components having similar functions.

The storage unit 201 includes one or more memories such as a read-only memory (ROM) and a random access memory (RAM). The storage unit 201 stores computer programs for performing various operations to be described below and various types of information such as communication parameters for wireless communication. Aside from memories such as a ROM and a RAM, the storage unit 201 may include storage media such as a flexible disk, a hard disk, a solid-state drive (SSD), an optical disc, a magneto-optical disc, a Compact Disc Read-Only Memory (CD-ROM), a Compact Disc Recordable (CD-R), a magnetic tape, a nonvolatile memory card, and a Digital Versatile Disc (DVD). The storage unit 201 may include a plurality of storage media such as memories.

The control unit 202 includes one or more processors such as a central processing unit (CPU) and a microprocessing unit (MPU), for example. The control unit 202 controls the entire communication apparatus by executing computer programs stored in the storage unit 201. The control unit 202 may control the entire communication apparatus through cooperation of the computer programs stored in the storage unit 201 and an operating system (OS). The control unit 202 generates data and signals (e.g., wireless frames) to be transmitted during communication with other communication apparatuses. The control unit 202 may include a plurality of processors like a multi-core processor, and perform various controls using the plurality of processors. The control unit 202 may include, for example, an application-specific integrated circuit (ASIC), a digital signal processor (DSP), or a field-programmable gate array (FPGA).

The control unit 202 controls the functional unit 203 to perform wireless communication and predetermined processing such as imaging, printing, and projection. The functional unit 203 includes hardware for the communication apparatus to perform the predetermined processing. If, for example, the communication apparatus is a printer, the functional unit 203 is a printing device, and performs print processing such as printing image data acquired via, e.g., the communication unit 206. If, for example, the communication apparatus is a scanner, the functional unit 203 is a reading device, performs scan processing such as performing a scan to generate image data, and outputs the generated image data to the outside via, e.g., the communication unit 206. If, for example, the communication apparatus is a camera, the functional unit 203 includes an image sensor and a lens, performs imaging processing, and outputs image data captured by the camera to the outside via, e.g., the communication unit 206. The functional unit 203 may include components for implementing AP functions or STA functions. Data to be processed by the functional unit 203 may be data stored in the storage unit 201 or data communicated with other communication apparatuses via the communication unit 206.

The input unit 204 includes a touchscreen, hardware keys, and/or buttons, for example, and accepts various operations from the user. The output unit 205 includes a display and a speaker, and provides various outputs to the user. Examples of the outputs by the output unit 205 may include screen display output on the display and audio output using the speaker. The output unit 205 may include a vibrator and output information via vibration output. Like a touchscreen display, the input unit 204 and the output unit 205 both may be implemented by a single module. The input unit 204 and the output unit 205 may be built into the communication apparatus, or implemented by external input/output devices. In the latter case, the communication apparatus includes an input/output interface for connecting to the input/output devices.

The communication unit 206 executes control for performing wireless communication compliant with the IEEE 802.11 series standards. For example, the communication unit 206 may control wireless communication compliant with the IEEE 802.11bn standard, subsequent successor standards, preceding legacy standards, and the like, and control wired communication such as wired LAN communication. The communication unit 206 controls the antenna 207 to transmit and receive signals for wireless communication, generated by the control unit 202. For example, the communication apparatus communicates data such as image data, document data, and video data with partner communication apparatuses via the communication unit 206. If the communication apparatus supports near-field communication (NFC) standards, Bluetooth® standards, and the like in addition to the IEEE 802.11 series standards, the communication unit 206 may control wireless communication compliant with such communication standards. If the communication apparatus can perform wireless communication compliant with a plurality of communication standards, communication units and antennas corresponding to the respective communication standards may be separately prepared.

The antenna 207 is one capable of detecting and emitting radio waves in the 2.4-, 5-, and 6-GHz bands. The antenna 207 may be configured to be capable of communication in the same frequency bands as those used by the communication unit 206.

In such a case, the antenna 207 may be a multi-band antennal capable of communication in multiple frequency bands, for example. While FIG. 2 illustrates an example where the communication apparatus includes only one antenna, as many antennas as the number of usable spatial streams may be used. If the communication apparatus includes a plurality of antennas, communication units 206 corresponding to the respective antennas may be included. The antenna 207 may be prepared separate from the communication unit 206, or configured together with the communication unit 206 as a single module.

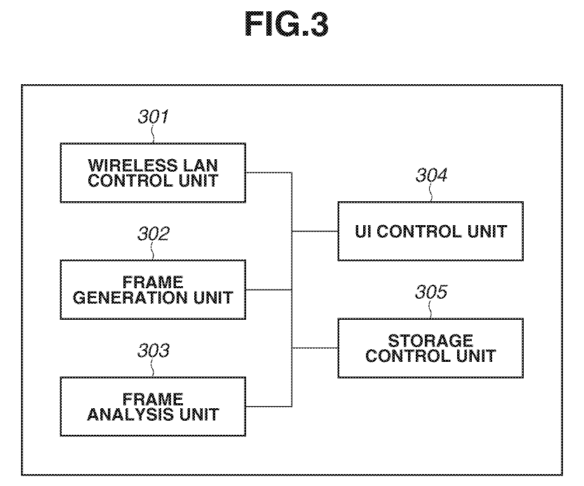

FIG. 3 is a diagram illustrating a functional configuration example of the communication apparatuses (e.g., APs and STAs) according to the present embodiment.

Each communication apparatus includes, as an example of its functional configuration, a wireless LAN connection unit 301, a frame generation unit 302, a frame analysis unit 303, a user interface (UI) control unit 304, and a storage control unit 305. The functional configuration illustrated in FIG. 3 is merely an example, and other functions may be added or the illustrated functions may be modified. For example, one functional block illustrated in FIG. 3 may be divided into a plurality of blocks. A plurality of functional blocks may be integrated into one. Some of the functions may be omitted. Not-illustrated functions may be added. For example, at least some of the functions illustrated in FIG. 3 may be implemented by the control unit 202 executing programs stored in the storage unit 201 (for example, all the functions illustrated in FIG. 3 may be implemented by software). Alternatively, at least some of the functions illustrated in FIG. 3 may be implemented by using dedicated hardware. The names of the functional blocks illustrated in FIG. 3 are merely examples, and may be changed.

The wireless LAN control unit 301 controls wireless LAN communication. To transmit and receive wireless signals to/from other communication apparatuses capable of performing wireless LAN communication, the wireless LAN control unit 301 controls the communication unit 206 and the antenna 207. For example, the wireless LAN control unit 301 cooperates with the frame generation unit 302 and/or the frame analysis unit 303 to perform communication control of wireless frames in conformity with the IEEE 802.11 series standards.

For example, when the primary channel out of the primary and secondary channels is unavailable, the wireless LAN control unit 301 transmits to another communication apparatus a wireless frame related to performing communication with another communication apparatus using the secondary channel(s). For example, when the primary channel out of the primary and secondary channels is unavailable, the wireless LAN control unit 301 receives from another communication apparatus a wireless frame related to performing communication with another communication apparatus using the secondary channel(s). The primary channel (e.g., first channel) and the secondary channel(s) (e.g., second channel[s]) are bonded with each other. The wireless frame includes information indicating whether to continue transmission and reception of the wireless frame during the communication using the foregoing secondary channel(s) (for example, whether to perform repetitive transmissions). The wireless frame may be a trigger frame (e.g., ICF) for issuing a notification to perform communication with another communication apparatus using the foregoing secondary channel(s) or a response frame (e.g., ICR) to the trigger frame.

The specific channel (e.g., primary channel) is also referred to as a BSS primary channel. Any one of one or more secondary channels typically bonded and used with the BSS primary channel is used as a transition destination channel in performing NPCA. For example, when a BSS provided by an AP has a bandwidth of 80 MHz, four 20-MHz channels are bonded for operation. One of the channels is classified as the BSS primary channel, and the other three as secondary channels. The transition destination channel is one of the remaining three secondary channels. To uniquely identify the transition destination channel between the AP and the STA, the transition destination channel is decided by the AP and notified from the AP to the STA. Information indicating the transition destination channel is included in, for example, a Probe Response frame, a Beacon frame, an Association Response frame, an Authentication Response frame, or the like, and notified to the STA. More specifically, the AP notifies the STA of the transition destination channel by including the information indicating the transition destination channel into a UHR Operation Element. The transition destination channel functions as a reference channel in performing NPCA, and is thus also referred to as an NPCA primary channel. In the present embodiment, the NPCA primary channel will also be referred to simply as a Non-Primary Channel (NPCH).

For example, the wireless LAN control unit 301 determines (e.g., or decides) whether to continue the transmission and reception of the foregoing wireless frames based on at least one of communication quality between the communication apparatus and another communication apparatus, the amount of information to be transmitted by the communication apparatus, and a state of the communication apparatus. The communication quality may be a received signal strength indication (RSSI) or a signal-to-noise ratio (SNR).

The state of the communication apparatus may include a processing load of the communication apparatus, an operation mode in which the communication apparatus is operating, and a battery state of the communication apparatus. Possible operation modes may include a power save mode, an enhanced multi-link single radio (EMLSR) mode, and an enhanced multi-link multi ratio (EMLMR) mode.

The wireless LAN control unit 301 is an example of a transmission unit or transmission part, a reception unit or reception part, a transmission and reception unit or transmission and reception part, a communication unit or communication part, a determination unit or determination part, a decision unit or decision part, etc.

The frame generation unit 302 generates control frames (e.g., wireless frames) such as an ICF and an ICR to be described below. The frame generation unit 302 also generates other types of wireless frames, such as management frames and data frames. Each wireless frame includes a medium access control (MAC) frame. The MAC frame is also referred to as a MAC protocol data unit (MPDU) or Aggregate MPDU (A-MPDU). A wireless frame includes a preamble field and a data field. The data field stores a MAC frame such as a management frame, a control frame, and a data frame. Wireless control may be performed using MAC frames generated by the frame generation unit 302. The content of wireless control here may be restricted by settings stored in the storage unit 201 by the storage control unit 305. The frame generation unit 302 may accept user settings via the UI control unit 304. Wireless frames generated by the frame generation unit 302 may be supplied to the wireless LAN control unit 301 and transmitted to the outside under the control of the wireless LAN control 301, using the operation unit 206 and the antenna 207. For example, the APs and the STAs may transmit and receive UHR PPDUs, which are wireless frames compliant with the IEEE 802.11bn standard.

The frame analysis unit 303 analyzes wireless frames received via the communication unit 206 and the antenna 207 under the control of the wireless LAN control unit 301. When analyzing wireless frames, the frame analysis unit 303 may determine the analysis method based on the settings stored in the storage unit 201 by the storage control unit 305.

The UI control unit 304 controls the input unit 204 to accept input to UIs such as a touchscreen and buttons for accepting a not-illustrated user's operations on the communication apparatus. The UI control unit 304 may also control the output unit 205, for example, to perform control for presenting information to the user, such as displaying images and providing audio output. The UI control unit 304 may also control the input unit 204 and the output unit 205, for example, to display a graphical UI (GUI) on the display and accept operations to the GUI.

The storage control unit 305 controls the storage unit 201 to perform control related to storage of various types of information, such as storing, searching, and extracting programs and data with which the communication apparatus operates.

### Frame Configuration

Next, configuration examples of wireless frames to be transmitted and received by the communication apparatuses will be described.

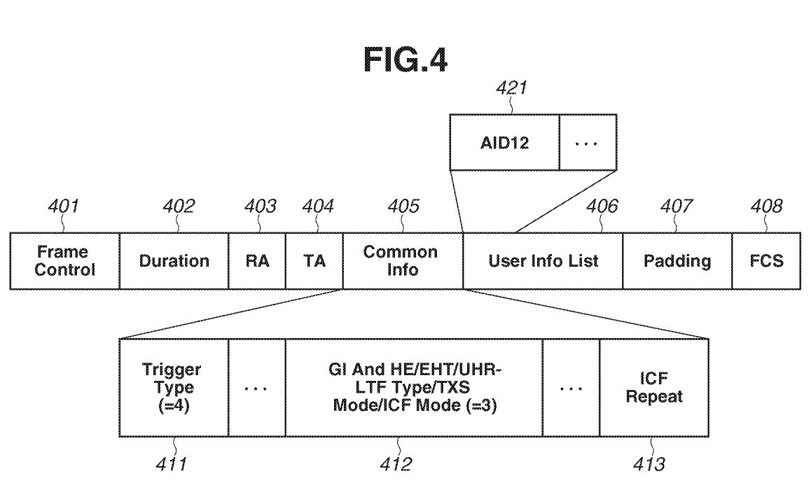

FIG. 4 is a diagram illustrating a configuration example of an ICF according to the present embodiment, illustrating a configuration example of an ICF MAC frame. The ICF according to the present embodiment may be transmitted by an AP or by an STA.

The ICF includes a Frame Control field 401, a Duration field 402, a receiver address (RA) field 403, a transmitter address (TA) field 404, a Common Info field 405, and a User Info List field 406. The ICF also includes a Padding field 407 and a frame check sequence (FCS) field 408. It should be noted that the names of the fields and subfields used in FIG. 4 and its description are for illustrative purposes, and at least some of the fields and subfields may be called by different names having the same functions. Some "fields" may be rephrased with "subfields", and "subfields" with "fields". At least some of the fields or subfields described below may be omitted. Additional fields or subfields may be added. In other words, the frame configuration described below is merely an example, and frames of any configuration including a field or fields serving at least some of the functions of the configuration according to the present embodiment to be described below are encompassed within the scope of the present embodiment.

The same applies to other frames to be described below (e.g., ICR).

The Frame Control field 401 is a field where information related to control of the entire frame is stored. The Frame Control field 401 stores information indicating the type of this frame, etc. For example, setting a 2-bit Type field constituted by the third and second bits of the Frame Control field 401 to "01 = (1)" indicates that this frame is a control frame. Setting a 4-bit Subtype field constituted by the seventh to fourth bits of the Frame Control field 401 to "0010 = (2)" indicates that this frame is a trigger frame. In other words, an ICF of BSRP GI3 format is a frame where the combination of the Type field and the Subtype field in the Frame Control field 401 is "01" and "0010". While the Frame Control field 401 also stores various other types of information, a description thereof will be omitted here.

The Duration field 402 is a field storing information indicating a period needed to transmit the frame.

The RA field 403 is a field storing the MAC address (RA) of the receiver of this frame.

The TA field 404 is a field storing the MAC address (TA) of the transmitter of this frame.

The Common Info field 405 is a field storing information common to all users (e.g., receivers) of this frame.

The Common Info field 405 includes a Trigger Type field 411 and a GI And HE/EHT/UHR-LTF Type/TXS Mode/ICF Mode field 412. Hereinafter, the GI And HE/EHT/UHR-LTF Type/TXS Mode/ICF Mode field 412 will be also referred to simply as a GI field 412. In the ICF of BSRP GI3 format, the Trigger Type field 411 of 4-bit constituted by the third to zeroth bits is set to "0100 (= 4)", which indicates BSRP. In the ICF of BSRP GI3 format, the 2-bit GI field 412 constituted by the twenty-first and twentieth bits is set to "11 (=3)". The trigger frame with the Trigger Type field 411 and the GI field 412 set to "4" and "3", respectively, is called BSRP GI3. In the present embodiment, a new field called an ICF Repeat field 413 is added to the Common Info field 405. This ICF Repeat field 413 can indicate a frame related to which feature of the IEEE 802.11bn and other standards this ICF frame is (in this example, a frame related to whether to continue the transmission and reception of ICFs and ICRs). A new field (e.g., 1-bit field) indicating execution of NPCA (e.g., field indicating whether to execute NPCA) may be added to the Common Info field 405. It may thereby be indicated that this ICF is a frame related to NPCA (whether this ICF is a frame related to NPCA).

The User Info List field 406 includes one or more User Info fields. The User Info fields are fields storing control information specific to respective users (e.g., receivers).

The User Info List field 406 also includes an AID12 subfield. If an STA receives the ICF, the AID12 subfield 421 may store an Association Identifier (AID) that is identification information about the STA that receives the ICF. On the other hand, if an STA transmits the ICF, the AID12 subfield 421 may store an AID that is the identification information about the STA that transmits the ICF, or a specific value (e.g., 2008). The AID12 subfield 421 may be included in a Special User Info field (not illustrated) in the User Info List field 406.

The padding field 407 is a field used to adjust the frame length.

The FCS field 408 stores information indicating an FCS value for error detection.

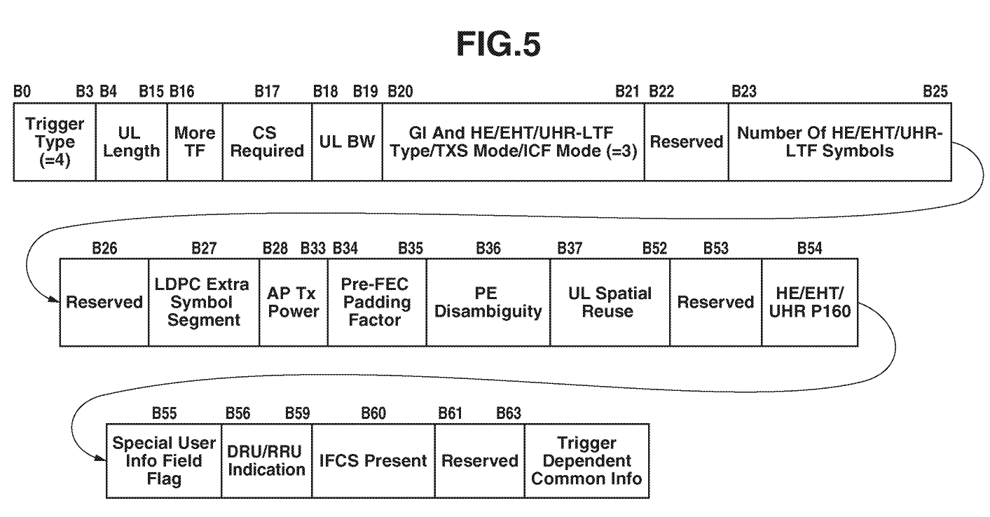

Now, in relation to the Common Info field 405, a configuration of a conventional Common Info field will be described. FIG. 5 is a diagram illustrating a configuration example of the conventional Common Info field. In FIG. 5, bit positions in the Common Info field are expressed by "Bx", which represents an x-th bit. In the conventional Common Info field, as described above, the Trigger Type field and the GI And HE/EHT/UHR-LTF Type/TXS Mode/ICF Mode field are set to "4" and "3", respectively. The conventional Common Info field stores various other information, and also includes a plurality of unused areas (e.g., reserved areas) as illustrated in FIG. 5. By using such areas for the ICF Repeat field 413, the ICF Repeat field 413 can be prepared without changing the format of the conventional Common Info field. For example, three bits consisting of the 63rd to 61st bits may be used as the ICF Repeat field 413. If four or more bits are needed for the ICF Repeat field 413, at least one of the 22nd, 26th, and 53rd bits may be additionally used. As another example, the 22nd, 26th, and 53rd bits may be used for a 3-bit ICF Repeat field 413. Moreover, only some of the 63rd to 61st bits may be used in combination with at least one of the 22nd, 26th, and 53rd bits. In other words, the ICF Repeat field 413 may be prepared by using any given reserved areas in the conventional Common Info field. The ICF Repeat field 413 may consist of two bits or fewer. The foregoing configuration of the ICF Repeat field 413 is merely an example, and the ICF Repeat field 413 may be prepared by modifying the format of the Common Info field. For example, the ICF Repeat field 413 may be located immediately after the GI And HE/EHT/UHR-LTF Type/TXS Mode/ICF Mode field. Alternatively, the ICF Repeat field 413 may be prepared as a part of a Trigger Dependent Common Info field (e.g., reserved areas may be used, or a new field may be used).

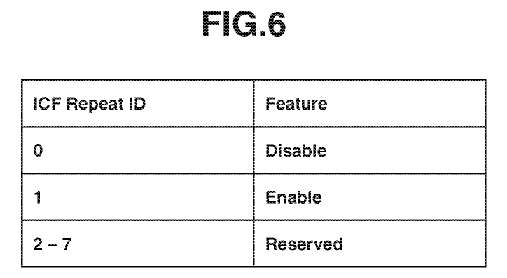

Next, an application example of the ICF Repeat field 413 will be described with reference to FIG. 6. In this example, values of the ICF Repeat field 413 (e.g., ICF Repeat ID) are associated with respective communication features. In this example, the communication features include not transmitting or receiving ICFs and ICRs during NPCA communication after the transmission and reception of an ICR to this ICF, and transmitting and receiving ICFs and ICRs during NPCA communication even after the transmission and reception of an ICR to this ICF. For example, the value of the ICF Repeat field 413 being "0" (e.g., Disable) indicates (e.g., means) that the transmission and reception of ICFs and ICRs will not be performed (e.g., not continued) during NPCA communication after the transmission and reception of an ICR to this ICF. The value of the ICF Repeat field 413 being "1" (e.g., Enable) indicates (e.g., means) that the transmission and reception of ICFs and ICRs will be performed (e.g., continued) during NPCA communication even after the transmission and reception of an ICR to this ICF. The name of the ICF Repeat field 413 and the association between the values and the features are merely an example, and other combinations of the name and the association between the values and the features may be used. For example, instead of or in addition to the ICF Repeat field 413, there may be a field indicating whether ICFs need to be exchanged in units of PPDUs. Examples of the name of such a field may include Per-Exchange ICF Required. The value of this field being "1" indicates (e.g., means) that an ICF needs to be transmitted upon each frame exchange sequence where a single PPDU is exchanged. The value of this field being "0" indicates (e.g., means) that ICF transmission is not mandatory for each frame exchange sequence where a single PPDU is exchanged. In other words, the value being "0" means that ICF transmission can be omitted in the case of performing NPCA communication after the initial ICF/ICR. While in the foregoing example the ICF Repeat field 413 is described to be a single bit to indicate two features, the number of bits of the ICF Repeat field 413 is not limited to one. For example, the ICF Repeat field 413 may be configured in two or more bits to accommodate future features, and the values not used at present may be reserved (e.g., values "2" to "7" in FIG. 6).

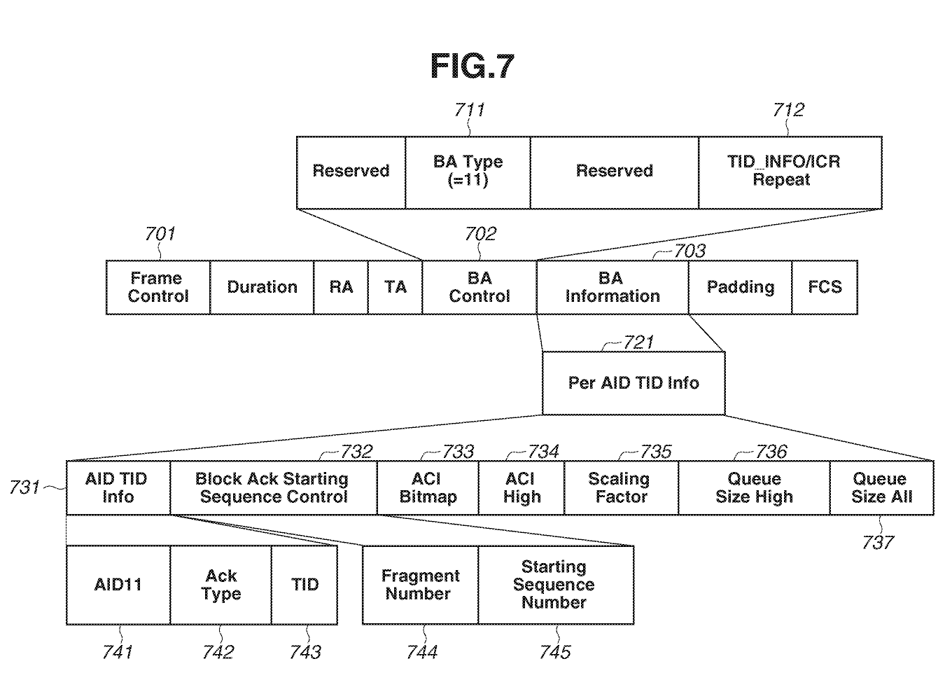

Next, a frame configuration of an ICR that a communication apparatus receiving the foregoing ICF transmits (e.g., the ICR according to the present embodiment may be transmitted by an AP or by an STA). FIG. 7 is a diagram illustrating a configuration example of the ICR according to the present embodiment, illustrating a configuration example of the MAC frame. FIG. 7 also illustrates a configuration example of an ICR to which information meaning whether to continue the transmission and reception of ICFs and ICRs is added. The MAC frame of this ICR is used, for example, as a response to an NPCA ICF. Use of an M-BA frame as the ICR is currently under study. An ICR of M-BA format will thus be described.

The ICR of M-BA format includes a Frame Control field 701, a BA Control field 702, and a BA Information field 703.

In the ICR of M-BA format, a Type field and a Subtype field included in the Frame Control field 701 are set to "01" and "1001", respectively. This indicates that this frame is a BA frame.

A BA frame includes a BA Control field 702. The BA Control field 702 includes a BA Type subfield 711. In the ICR of M-BA format, aside from the settings of the Type field and the Subtype field included in the Frame Control field 701, the BA Type subfield 711 is set to "1011 (= 11)". The value "1011 (= 11)" indicates that the BA type is a multi-STA type (M-BA). This indicates that this frame is an M-BA frame.

The BA Information field 703 further indicates that this frame is an ICR. Specifically, the BA Information field 703 includes a Per AID TID Info field 721. The Per AID TID Info field 721 includes an AID TID Info field 731. The AID TID Info field 731 includes a 1-bit Ack Type subfield 742 and a 4-bit TID subfield 742. The Ack Type subfield 742 and the TID subfield 743 being set to "0" and "1101 (= 13)", respectively, indicates that this frame is an ICR. An AID11 subfield 741 included in the AID TID Info field 731 may store an AID that is the identification information about the STA transmitting this ICR, or a specific value (for example, 2008).

In the present embodiment, the communication apparatus may include in this frame an ICR Repeat indicating a response related to which feature of the IEEE 802.11bn and other standards this ICR is. In the example illustrated in FIG. 7, the BA Control field 702 includes a TID_INFO/ICR Repeat subfield 712, which is a TID_INFO subfield containing ICR Repeat information. In other words, the TID_INFO subfield may be used as an ICR Repeat subfield in this frame. Note that this configuration is merely an example. For example, existing reserved areas may be used as the ICR Repeat subfield. As the existing reserved areas, the reserved area between the BA Type subfield 711 and the TID_INFO subfield included in the BA Control field 702 and the like may be used. A new field for indicating ICR Repeat may be defined. The ICR Repeat may store the same value as or a similar value to that described with reference to FIG. 6. One or more bits indicating that this frame is an ICR corresponding to an ICF (of BSRP GI3 format) may be prepared aside from the ICR Repeat. As an example, when the communication apparatus having transmitted the ICF receives an ICR that includes the address of the own apparatus in the RA field and also includes one bit indicating that the ICR corresponds to an ICF, the communication apparatus may identify the received ICR as an ICR corresponding to the transmitted ICF. As another example, the ICF may include information such as a token for identifying the frame, and the same value as the token or the like may be included in the ICR. That is, if it is sufficient to identify that the type of communication specified by the ICF is accepted, the ICR does not need to include the ICR Repeat, provided that the ICR is in a format that enables identification as being a response to an ICF. For example, the reserved area between the BA Type subfield 711 and the TID_INFO subfield may be used for that purpose. The information about the ICR Repeat is also information indicating (e.g., meaning) that the transmission and reception of ICFs and ICRs will not be continued.

The ICR stores information indicating the buffer status at the transmitter of the ICR. FIG. 7 illustrates a configuration example of the ICR storing such information. In this example, the BA Information field 703 includes the following fields arranged after a Block Ack Starting Sequence Control field 732. That is, an Access Category Index (ACI) Bitmap field 733, an ACI High field 734, and a Scaling Factor field 735 are arranged in this order. After the Scaling Factor field 735, a Queue Size High field 736 and a Queue Size All field 737 are arranged in this order. In an ordinary M-BA, the Block Ack Starting Sequence Control field 732 is followed by a Block Ack Bitmap field. Instead, in the ICR, the Block Ack Starting Sequence Control field 732 may be followed by a value (for example, "1" if the ICF is successfully received [e.g., decoded], and "0" if the ICF fails to be received [e.g., decoded]). The information stored in the ACI Bitmap field 733 to the Queue Size All field 737 corresponds to information that is conventionally transmitted by a Buffer Status Report (BSR). The ACI Bitmap field 733 to the Queue Size All field 737 may be handled as subfields in the Block Ack Bitmap field.

The ACI Bitmap field 733 is a bitmap field indicating data of which access category (AC) is pending in the queue of the transmitter of this ICR. The number of bits of this bitmap (ACI Bitmap field 733) is four. The zeroth, first, second, and third bits of the four bits correspond to best effort (AC_BE), background (AC_BK), video (AC_VI), and voice (AC_VO), respectively. In this bitmap, bits corresponding to ACs where data is pending are set to "1", and bits corresponding to ACs where no data is pending are set to "0".

The ACI High field 734 is a field storing information indicating the AC whose queue size (e.g., amount of data pending in the queue) is the largest.

The Scaling Factor field 735 is a field storing the scaling factor of the queue size to be reported. The queue size is reported in units of the number of octets indicated by the Scaling Factor field 735.

For example, if the value of the Scaling Factor field 735 is "0", the queue size is reported in units of 16 octets. For example, if the value of the Scaling Factor field 735 is "1", the queue size is reported in units of 256 octets. For example, if the value of the Scaling Factor field 735 is "2", the queue size is reported in units of 2048 octets. For example, if the value of the Scaling Factor field 735 is "3", the queue size is reported in units of 32768 octets. If the unit of the queue size to be reported is determined in advance, the Scaling Factor field 735 may be omitted.

The Queue Size High field 736 is a field storing a value indicating the queue size of the AC indicated by the ACI High field 734.

The Queue Size All field 737 is a field storing a value indicating the total queue size of all the ACs.

The Block Ack Starting Sequence Control field 732 includes a Fragment Number subfield 744 and a Starting Sequence Number subfield 745. The Fragment Number subfield 744 and the Starting Sequence Number subfield 745 are similar to those of the conventional M-BA. A description thereof will therefore be omitted here.

### System Operation

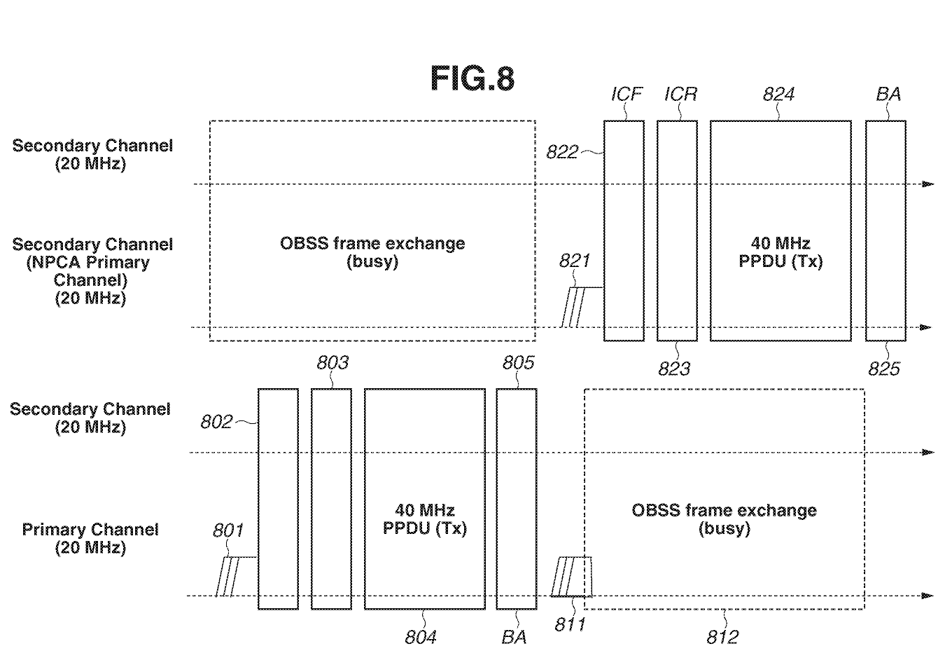

An example of a communication procedure using the foregoing frames will be described with reference to FIG. 8. FIG. 8 is a diagram illustrating an example of a procedure for communication processing using NPCA according to the present embodiment.

Communication apparatuses perform carrier sensing on the primary channel during a backoff period 801, and if no signal from another network (OBSS) is detected, determine that one or more channels including the primary channel can be used. For example, an AP transmits a BSRP frame 802 to an STA and receives a BSR frame 802, thereby identifying the amount of data pending in the queue of the STA. The BSRP frame 802 and the BSR frame 803 may be conventional frames. The AP then receives data (e.g., PPDU 804) from the STA (e.g., or transmits data to the STA). The receiver of the data between the AP and the STA then transmits a Block Ack (BA) 805, and the transmitter of the data receives the BA 805. For example, the AP and the STA may transmit and receive frames over a frequency bandwidth of 40 MHz, using the primary channel as well as a channel not used by the OBSS.

To continue communication with the STA, the AP then performs carrier sensing on the primary channel during a backoff period 811. Here, if the primary channel is being used for frame exchange 812 by the OBSS, the AP determines that communication using the primary channel is unable to be performed. In such a case, the AP uses NPCA to perform communication using only secondary channels without using the primary channel. In this case, during a backoff period 821, the AP performs carrier sensing on the NPCA primary channel targeted for carrier sensing among secondary channels. If this NPCA primary channel is confirmed to not have been used throughout the backoff period 821, the AP then transmits an ICF 822 in response. For example, the ICF 822 is an ICF where the ICF Repeat field 413 is set to "Disable", "Enable", or the like in FIG. 6. The STA then transmits an ICR 823 such as illustrated in FIG. 7 to the AP. The AP and the STA then transmit and receive a PPDU 824 without using the primary channel. When causing the STA to transmit the PPDU 824, the AP may transmit a trigger frame. This trigger frame may be a conventional trigger frame (e.g., Basic Trigger) rather than an ICF, for example, but an ICF may be used instead. The receiver of the data between the AP and the STA then transmits a BA 825, and the transmitter of the data receives the BA 825. In such a manner, NPCA-based communication can be efficiently performed using the ICF and ICR.

The carrier sensing performed on the primary channel and/or the secondary channel may be physical carrier sensing, virtual carrier sensing, or both.

In the foregoing example, the configurations of the ICF and the ICR have been described in conjunction with the respective features of the IEEE 802.11bn and other standards. However, the described configurations are merely examples. That is, the information transmitted by the ICF, ICR, and the like in the foregoing example is just an example, and the configurations of the ICF, ICR, and the like may be modified to include other information for enabling communication associated with the features. Moreover, ICFs, ICRs, and the like may be similarly used not only for the features adopted in IEEE 802.11bn and its successor standards but also for features employed in standards prior to the IEEE 802.11be standard. ICFs of BSRP GI3 format and ICRs of M-BA format may be configured so that the frames do not include ICF Repeat or ICR Repeat for some features. In other words, when a specific feature is implemented, it may be implicitly indicated by the absence of ICF Repeat, ICR Repeat, and the like in ICFs, ICRs, and the like, respectively, that the ICFs and ICRs are ones related to the specific feature.

Next, examples of processing procedures to be performed by the communication apparatuses will be described.

### Example 1

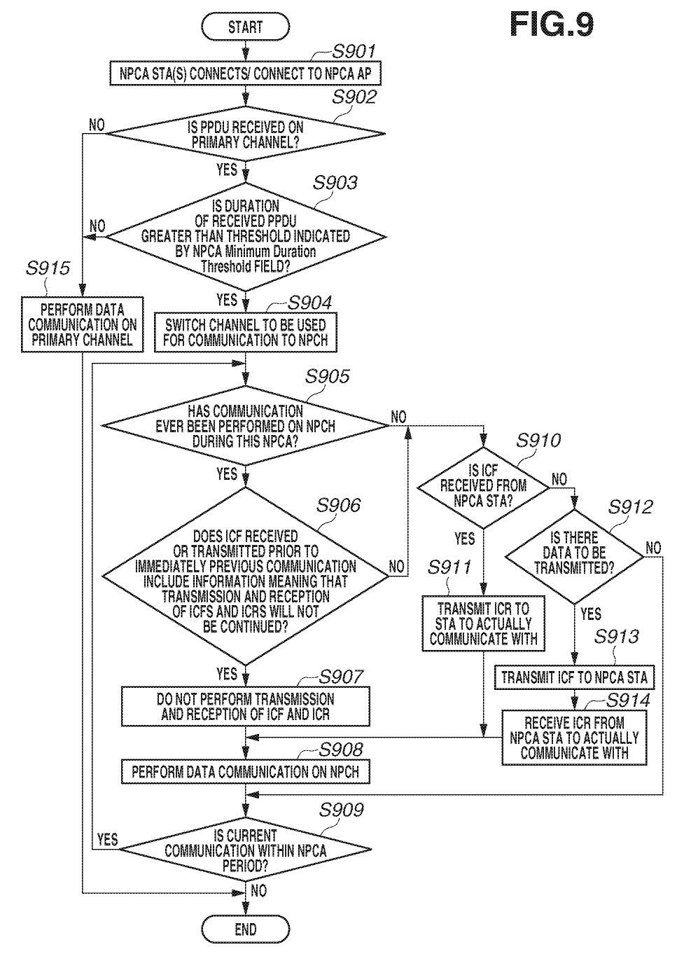

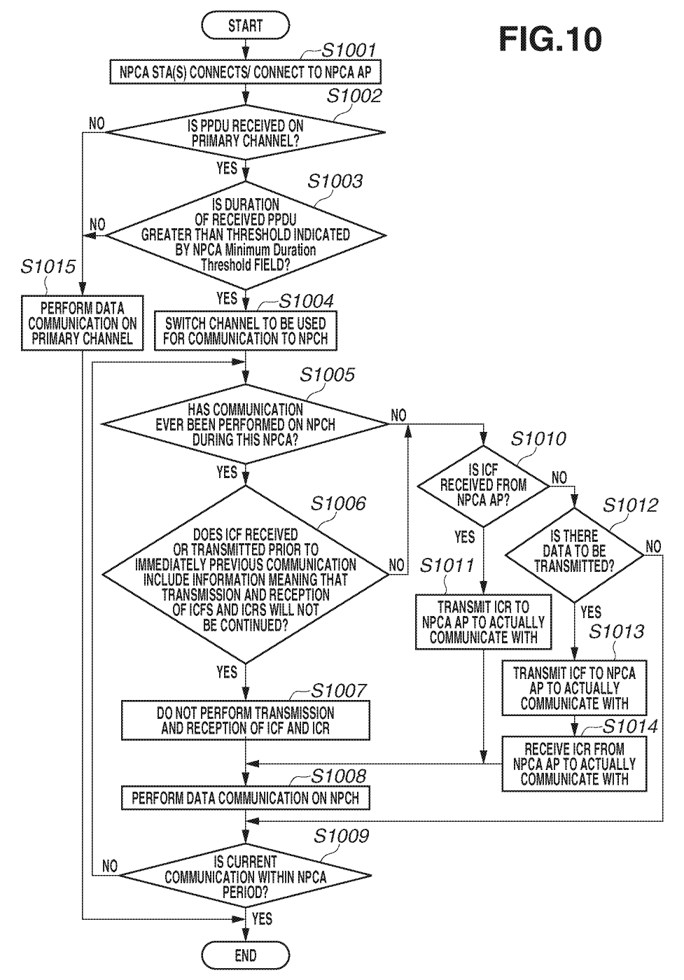

An example of a processing procedure when an AP initiates communication with an STA will initially be described with reference to FIG. 9. FIG. 9 is a flowchart illustrating an example of processing for performing NPCA according to the present embodiment. APs and STAs supporting NPCA will be referred to as NPCA APs and NPCA STAs, respectively. In FIGS. 9 (and FIG. 10), such an AP and an STA are referred to as an NPCA AP and an NPCA STA, respectively.

In step S901, the STA initially connects to the AP. Here, a plurality of STAs may connect to the AP.

When initiating communication after the completion of the connection, in step S902, the AP determines whether a PPDU being communicated on the primary channel (for example, PPDU from the OBSS) is received. If a PPDU is received on the primary channel (YES in step S902), the processing proceeds to step S903. If no PPDU is received on the primary channel (NO in step S902), the processing proceeds to step S915.

In step S903, the AP determines whether the duration of the received PPDU (e.g., notified by Legacy Signal [L-SIG]) is greater than a threshold indicated by an NPCA Minimum Duration Threshold field, for example. The NPCA Minimum Duration Threshold field is included in an NPCA Operation Information field in a UHR Operation Element, for example. The UHR Operation Element may be included in frames such as Beacon, Probe Request, Probe Response, Association Request, Association Response, and Action. If the duration of the PPDU is greater than the threshold (YES in step S903), the AP determines that the primary channel is busy, and the processing proceeds to step S904. On the other hand, if the duration of the PPDU is not greater than the threshold (NO in step S903), the AP determines that the primary channel is not busy, and the processing proceeds to step S915. Alternatively, the processing may proceed to step S904 if the duration of the PPDU is greater than or equal to the threshold, and proceed to step S915 if the duration of the PPDU is less than the threshold.

In step S904, the AP switches the channel to be used for communication to a secondary channel (e.g., also referred to as NPCH). The processing then proceeds to step S905. Between steps S903 and S904, the AP may perform carrier sensing on the NPCH to check that the NPCH is not used.

After the channel to be used is switched to the NPCH, in step S905, the AP checks where communication has ever been performed on the NPCH during this NPCA. If communication has been performed on the NPCH during this NPCA (YES in step S905), the processing proceeds to step S906. If no communication has been performed on the NPCH during this NPCA (NO in step S905), the processing proceeds to step S910.

In step S906, the AP determines whether the ICF received or transmitted in the earlier communication (e.g., prior to the immediately previous communication) includes information meaning that the transmission and reception of ICFs and ICRs will not be continued. Note that if an ICR includes information indicating whether to continue the transmission and reception of ICFs and ICRs, the AP may determine whether the ICR includes information meaning that the transmission and reception of ICFs and ICRs will not be continued, instead of the ICF. If the ICF includes the foregoing information (YES in step S906), the processing proceeds to step S907. If the ICF does not include the foregoing information (NO in step S906), the processing proceeds to step S910.

In step S907, the AP does not perform the transmission and reception of an ICF and an ICR. In step S908, the AP performs data communication on the NPCH. The processing then proceeds to step S909.

In step S910, the AP checks whether an ICF is received from the STA. If an ICF is received from the STA (YES in step S910), the processing proceeds to step S911. If no ICF is received from the STA (NO in step S910), the processing proceeds to step S912.

In step S911, the AP transmits an ICR to the STA that has transmitted the ICF (e.g., the STA to actually communicate with). In step S908, the AP performs data communication on the NPCH. The processing then proceeds to step S909.

In step S912, the AP checks whether there is data to be transmitted. If there is data to be transmitted (YES in step S912), the processing proceeds to step S913. If there is no data to be transmitted (NO in step S912), the processing proceeds to step S909.

In step S913, the AP transmits an ICF to the STA. In step S914, the AP receives an ICR that is transmitted by the STA in response to the transmitted ICF. In step S908, the AP performs data communication on the NPCH. The processing then proceeds to step S909.

After the data communication on the NPCH or after the switching to the NPCH without data communication, in step S909, the AP checks whether the current communication is within the NPCA period. If the current communication is within the NPCA period (YES in step S909), the AP determines that the NPCA continues, and the processing returns to step S905 to continue communication on the NPCH. On the other hand, if the current communication is not within the NPCA period (NO in step S909), the AP determines that the NPCA has ended, and ends the communication on the NPCH. The processing ends.

In step S915, the AP performs data communication on the primary channel. The processing ends.

As described above, the AP adds information indicating that the transmission and reception of ICFs and ICRs will not be continued to an ICF to be transmitted, whereby ICFs and ICRs are not transmitted or received in subsequent data communication during the NPCA. This can reduce communication overhead. Moreover, the AP adds information indicating that the transmission and reception of ICFs and ICRs will be continued to an ICF, whereby missing of ICFs and ICRs can be prevented or reduced. This enables appropriate NPCA communication. The foregoing information may be added to an ICR to be transmitted by the AP.

### Example 2

Next, an example of a processing procedure when an STA initiates communication with an AP will be described with reference to FIG. 10. FIG. 10 is a flowchart illustrating an example of processing for performing NPCA according to the present embodiment.

In step S1001, the STA initially connects to the AP. Here, a plurality of STAs may connect to the AP.

When initiating communication after the completion of the connection, in step S1002, the STA checks whether a PPDU being communicated on the primary channel (for example, PPDU from the OBSS) is received. If a PPDU is received on the primary channel (YES in step S1002), the processing proceeds to step S1003. If no PPDU is received on the primary channel (NO in step S1002), the processing proceeds to step S1015.

In step S1003, the STA checks whether the duration of the received PPDU (e.g., notified by L-SIG) is greater than a threshold indicated by the NPCA Minimum Duration Threshold field, for example. The NPCA Minimum Duration Threshold field is included in the NPCA Operation Information field in a UHR Operation Element, for example. The UHR Operation Element may be included in frames such as Beacon, Probe Request, Probe Response, Association Request, Association Response, and Action. If the duration of the PPDU is greater than the threshold (YES in step S1003), the STA determines that the primary channel is busy, and the processing proceeds to step S1004.

On the other hand, if the duration of the PPDU is not greater than the threshold (NO in step S1003), the STA determines that the primary channel is not busy, and the processing proceeds to step S1015. Alternatively, the processing may proceed to step S1004 if the duration of the PPDU is greater than or equal to the threshold, and proceed to step S1015 if the duration of the PPDU is less than the threshold.

In step S1004, the STA switches the channel to be used for communication to a secondary channel (NPCH). The processing then proceeds to step S1005. Between steps S1003 and S1004, the STA may perform charrier sensing on the NPCH to check that the NPCH is not used.

After the channel to be used is switched to the NPCH, in step S1005, the STA checks whether communication has ever been performed on the NPCH during this NPCA. If communication has been performed on the NPCH during this NPCA (YES in step S1005), the processing proceeds to step S1006. If communication has not been performed on the NPCH during this NPCA (NO in step S1005), the processing proceeds to step S1010.

In step S1006, the STA checks whether the ICF received or transmitted in the earlier communication (e.g., prior to the immediately previous communication) includes information meaning that the transmission and reception of ICFs and ICRs will not be continued. Note that if an ICR includes information indicating whether to continue the transmission and reception of ICFs and ICRs, the STA may determine whether the ICR includes information meaning that the transmission and reception of ICFs and ICRs will not be continued, instead of the ICF. If the ICF includes the foregoing information (YES in step S1006), the processing proceeds to step S1007. If the ICF does not include the foregoing information (NO in step S1006), the processing proceeds to step S1010.

In step S1007, the STA does not perform the transmission and reception of an ICF and an ICR. In step S1008, the STA performs data communication on the NPCH. The processing then proceeds to step S1009.

In step S1010, the STA checks whether an ICF is received from the AP. If an ICF is received from the AP (YES in step S1010), the processing proceeds to step S1011. If no ICF is received from the AP (NO in step S1010), the processing proceeds to step S1012.

In step S1011, the STA transmits an ICR to the AP that has transmitted the ICF (e.g., the AP to actually communicate with). In step S1008, the STA performs data communication on the NPCH. The processing then proceeds to step S1009.

In step S1012, the STA checks whether there is data to be transmitted. If there is data to be transmitted (YES in step S1012), the processing proceeds to step S1013. If there is no data to be transmitted (NO in step S1012), the processing proceeds to step S1009.

In step S1013, the STA transmits an ICF to the AP. In step S1014, the STA receives an ICR that is transmitted by the AP in response to the transmitted ICF. In step S1008, the STA performs data communication on the NPCH. The processing then proceeds to step S1009.

After the data communication on the NPCH or after the switching to the NPCH without data communication, in step S1009, the STA checks whether the current communication is within the NPCA period. If the current communication is within the NPCA period (NO in step S1009), the STA determines that the NPCA continues, and the processing returns to step S1005 to continue communication on the NPCH. On the other hand, if the current communication is not within the NPCA period (NO in step S1009), the STA determines that the NPCA has ended, and ends the communication on the NPCH, and the processing ends.

In step S1015, the STA performs data communication on the primary channel. The processing ends.

In example 2, like example 1, the STA adds information indicating that the transmission and reception of ICFs and ICRs will not be continued to an ICF to be transmitted, whereby ICFs and ICRs are not transmitted or received in subsequent data communication during the NPCA. This can reduce communication overhead. Moreover, the STA adds information indicating that the transmission and reception of ICFs and ICRs will be continued to an ICF, whereby missing of ICFs and ICRs can be prevented or reduced. This enables appropriate NPCA communication. The foregoing information may be added to an ICR to be transmitted by the STA.

### Example 3

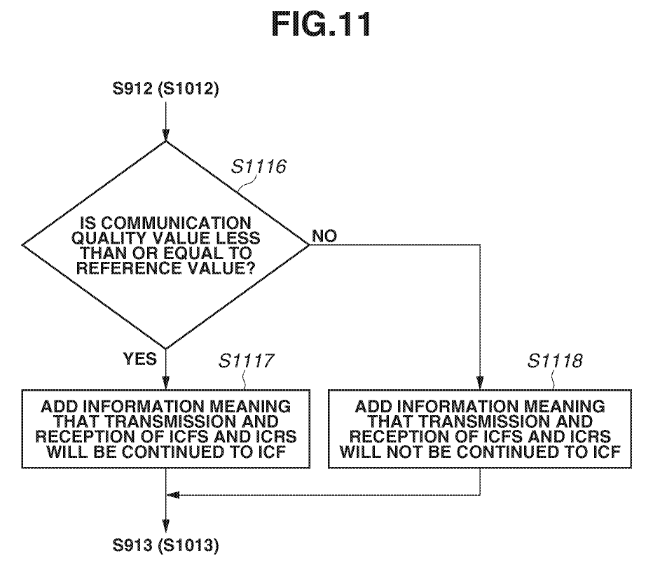

Next, processing by which the communication apparatuses (e.g., AP and STA) determine whether to continue the transmission and reception of ICFs and ICRs will be described with reference to FIG. 11. FIG. 11 is a flowchart illustrating an example of the processing for determining whether to continue the transmission and reception of ICFs and ICRs according to the present embodiment. In other words, FIG. 11 illustrates an example of processing for determining whether to add the information meaning that the transmission and reception of ICFs and ICRs will be continued or to add the information meaning that the transmission and reception of ICFs and ICRs will not be continued to an ICF. The determination may be made during NPCA, if data communication using the secondary channel has not been performed during the NPCA (NO in step S905 or S1005) and the AP or STA has not received an ICF (YES in step S912 or S1012). The determination may be made similarly (YES in step S912 or S1012) if the ICF or ICR transmitted or received in the immediately previous NPCA includes the foregoing information meaning the transmission and reception will not be continued (NO in step S906 or S1006). The processing illustrated in FIG. 11 may therefore be performed between steps S912 and S913 in FIG. 9. The processing illustrated in FIG. 11 may also be performed between steps S1012 and S1013 in FIG. 10.

In step S1116, the communication apparatus checks whether a communication quality value between the communication apparatuses (e.g., between the AP and the STA) is less than or equal to a reference value (e.g., or threshold). Any given value may be set as the reference value. Examples of the communication quality include an RSSI, an SNR, a signal-to-interference ratio (SIR), and a signal-to-interference-plus-noise ratio (SINR).

If the communication quality value is less than or equal to the reference value (YES in step S1116), the communication apparatus determines that ICFs and ICRs can be missed due to the poor radio wave environment, and the processing proceeds to step S1117. In step S1117, the communication apparatus adds the information meaning that the transmission and reception of ICFs and ICRs will be continued to an ICF. In other words, the communication apparatus here determines (e.g., or decides) to continue the transmission and reception of ICFs and ICRs.

On the other hand, if the communication quality value is greater than the reference value (NO in step S1116), the communication apparatus determines that the radio wave environment is not poor and that ICFs and ICRs are unlikely to be missed, and the processing proceeds to step S1118. In step S1118, the communication apparatus adds the information meaning that the transmission and reception of ICFs and ICRs will not be continued to an ICF. In other words, the communication apparatus here determines (or decides) to not continue the transmission and reception of ICFs and ICRs.

Alternatively, the communication apparatus may add the information meaning that the transmission and reception of ICFs and ICRs will be continued or will not be continued to an ICR.

The foregoing determination is not limited to being made based on the communication quality. The determination may be made, for example, based on at least one of the communication quality, the transmission data, the processing load (an example of the state of the communication apparatus), the operation mode (an example of the state of communication apparatus), the remaining battery level (an example of the state of the communication apparatus), and the like. For example, the communication apparatus may determine to not continue the transmission and reception of ICFs and ICRs if the amount of data or information to be transmitted by the AP or STA exceeds a reference value, and to continue the transmission and reception if not. For example, the communication apparatus may determine to not continue the transmission and reception of ICFs and ICRs if processing other than the processing related to NPCA communication is under heavy load (e.g., if the processor usage rate by the other processing exceeds a reference value), and to continue the transmission and reception if not. For example, the communication apparatus may determine to not continue the transmission and reception of ICFs and ICRs if the communication apparatus is operating in a specific operation mode (e.g., power save mode, EMLSR mode, EMLMR mode, or the like), and to continue the transmission and reception if not. The EMLSR mode and the EMLMR mode are modes used for power saving purposes. For example, the communication apparatus may determine to continue the transmission and reception of ICFs and ICRs if the remaining battery level of the communication apparatus falls below a reference value, and to continue the transmission and reception if not.

Determining whether the current situation is appropriate to continue the transmission and reception of ICFs and ICRs enables appropriate control of the transmission and reception of ICFs and ICRs during NPCA depending on the situation.

### OTHER EMBODIMENTS

In the foregoing present embodiment, the ICF Repeat field 413 is described to be included in the Common Info field 405. However, the ICF Repeat field 413 may be included in other fields. For example, the ICF Repeat field 413 may be included in the User Info List field 406. More specifically, the ICF Repeat field 413 may be included in a Special User Info field (not illustrated) in the User Info List field 406. The Special User Info field is a field capable of storing information that is common to all users (e.g., receivers) of this frame and unable to be accommodated in the Common Info field 405. Like the Common Info field 405, the ICF Repeat field 413 may therefore be included in the Special User Info field. As the ICF Repeat field 413 included in the Special User Info field, reserved areas may be used or a new field may be used. For example, if the trigger frame is a trigger frame of beamforming report poll (BFRP) format, all the Trigger Dependent User Info fields included in the Special User Information field are reserved areas. The ICF Repeat field 413 may therefore be included in the Trigger Dependent User Info fields.

In the foregoing description, the ICF Repeat field 413 is described to be included in the fields in the Common Info field 405 or the fields in the Special User Info field. The ICF Repeat field 413 may be included in one of these fields or more than one of these fields. Similarly, the information about the ICR Repeat may be included in one of the fields or more than one of the fields.

The foregoing embodiment has been described by using ICFs of BSRP format and ICRs of M-BA format as an example. However, the present disclosure is not limited to ICFs and ICRs of these formats. For example, the present disclosure may be applied to ICFs and/or ICRs of other formats, or other wireless frames. For example, frames of Request to Send (RTS) format may be used as the ICFs of another format. Frames of Clear to Send (CTS) format may be used as the ICRs of another format.

In the foregoing embodiment, communication triggered by the exchange of an ICF and an ICR has been described by using NPCA as an example. However, the present disclosure is not limited to communication during NPCA.

For example, the present disclosure may be applied to communication during Dynamic Subband Operation (DSO). In DSO, a special ICF that may be called a subband switching control frame (e.g., such as a frame of BSRP format or a frame of Multi-User [MU]-RTS format) may be used. This ICF and/or an ICR to the ICF may include information indicating whether to continue the transmission and reception of ICFs and ICRs. This information may be the foregoing information indicating whether an ICF needs to be transmitted upon each frame exchange sequence where one PPDU is exchanged.

The arrangement of the fields described above is not limited to the examples illustrated in the drawings of the present disclosure, and the fields may be arranged in a different order. The frames described above do not need to include all the fields illustrated in the drawings of the present disclosure, and may include only some of the fields. The frames described above may also include additional fields different from those illustrated in the drawings of the present disclosure.

The combinations of the field values and the corresponding meanings (content indicated by the values) are not limited to the examples described above. For example, the values "1" and "0" in 1-bit fields may have opposite meanings.

A storage medium storing software program code for implementing the foregoing functions may be supplied to a system or an apparatus, and a computer (e.g., CPU or MPU) of the system or apparatus may read and execute the program code stored in the storage medium. In such a case, the program code itself read from the storage medium implements the functions of the foregoing embodiment, and the storage medium storing the program code constitutes the foregoing apparatuses.

Examples of the storage medium for supplying the program code may include a flexible disk, a hard disk, an optical disc, a magneto-optical disc, a CD-ROM, a CD-R, a magnetic tape, a nonvolatile memory card, a ROM, and a DVD.

Moreover, the foregoing functions may be implemented not only by the computer executing the read program code, but also by an OS running on the computer performing part or all of the actual processing based on instructions of the program code.

Furthermore, the program code read from the storage medium may be written to a memory included in a function expansion board inserted into the computer or a function expansion unit connected to the computer.

The foregoing functions then may be implemented by a CPU included in the function extension board or the function extension unit performing part or all of the actual processing based on instructions of the program code.

The present disclosure can also be implemented by processing for supplying a program for implementing one or more functions of the foregoing embodiment to a system or an apparatus via a network or a storage medium, and reading and executing the program by one or more processor in a computer of the system or apparatus. The present disclosure can also be implemented by using a circuit for implementing one or more functions (e.g., such as an ASIC).

Part of the processing described with reference to the flowcharts in the present disclosure may be implemented by hardware. For example, a dedicated circuit may be automatically generated on an FPGA from the programs for implementing the foregoing steps. Like an FPGA, a gate array circuit may be formed for hardware implementation.

The names of the functional blocks, messages, parameters, fields, and the like described in the foregoing embodiment are merely examples, and may be changed to other names.

The processing procedures, sequences, flowcharts, and the like of the foregoing embodiment are not limited to the specific orders presented. The steps may be interchanged in order, or additional steps may be added, as long as no contradiction arises. Some of the steps may be omitted.

The features described in the foregoing embodiment and the features illustrated in the attached drawings may be considered as independent elements with their respective technical contributions. In other words, these features provide synergistic effects in the context of the foregoing detailed description, but not limited to such combinations and may be individually extracted and independently used to address specific issues or enhance specific functions. Moreover, the specific embodiment presented in the foregoing detailed description may include many modifications. Such embodiments are merely examples, and not intended to limit the scope, applicability, control, or configuration of the present disclosure. The foregoing detailed description rather provides those skilled in the art with an example of guidance for implementing practicable embodiments. In summary, various modifications may be made to the operations, methods, steps, units, and schemes described in the foregoing detailed description without departing from the appended claims. In other words, subject matter including components in which some of the operations, steps, units, schemes, and the like of the foregoing embodiment are substituted, modified, reconfigured, decomposed, and/or combined is also envisioned as patent-eligible subject matter that may possess its own technical contribution in the present disclosure. Furthermore, subject matter including components in which some of the operations, steps, units, schemes, and the like of the foregoing embodiment are omitted is also envisioned as patent-eligible subject matter that may possess its own technical contribution in the present disclosure. Subject matter including components in which some parts of the foregoing embodiment are substituted, modified, reconfigured, decomposed, and/or combined, and other parts thereof are omitted, is also envisioned as patent-eligible subject matter that may possess its own technical contribution in the present disclosure.

According to the present embodiment described above, information indicating whether to continue the transmission and reception of ICFs and ICRs during NPCA is included in an ICF of BSRP GI3 format, for example, and/or an ICR of M-BA format, for example. This enables appropriate transmission and reception of ICFs and ICRs to efficiently perform communication during NPCA. The transmission and reception of ICFs and ICRs during NPCA can thus be appropriately controlled.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-072618, filed Apr. 24, 2025, which is hereby incorporated by reference herein in its entirety.

What is claimed is:

1. A communication apparatus configured to perform communication compliant with an Institute of Electrical and Electronics Engineers (IEEE) 802.11 series standard, the communication apparatus comprising:
at least one memory that stores a set of instructions; and
at least one processor that executes the instructions, the instructions, when executed, causing the communication apparatus to perform operations including externally signaling information indicating whether transmission of an initial control frame (ICF) is permitted to be omitted when channel access is performed via a Non-Primary Channel Access (NPCA) primary channel to be used in a case where a basic service set (BSS) primary channel is unavailable.

2. The communication apparatus according to claim 1, wherein the signaling is performed via the NPCA primary channel.

3. The communication apparatus according to claim 2, wherein the signaling is performed by transmitting a trigger frame.

4. The communication apparatus according to claim 3, wherein the information is included in a Common Info frame in the trigger frame.

5. The communication apparatus according to claim 3, wherein the information is included in a User Info List field in the trigger frame.

6. The communication apparatus according to claim 3, wherein a Trigger Type field included in a Common Info field in the trigger frame is set to 4, and a GI And LTF Type field included in the Common Info field is set to 3.

7. The communication apparatus according to claim 1, wherein the signaling is performed using an initial control response (ICR) frame to an ICF transmitted at timing of an initial channel access after switching to the NPCA primary channel.

8. The communication apparatus according to claim 1, wherein if the signaled information indicates that the transmission of the ICF is permitted to be omitted, the communication apparatus is permitted to attempt transmission of a data frame without transmitting an ICF when performing a second or subsequent channel access after data exchange based on an initial channel access on the NPCA primary channel is completed and within an NPCA period.

9. The communication apparatus according to claim 8, wherein if the information indicates that the transmission of the ICF is not permitted to be omitted, the information triggers control that forces the communication apparatus to transmit the ICF in performing the second or subsequent channel access within the NPCA period to attempt acquisition of a data transmission opportunity.

10. The communication apparatus according to claim 1, wherein the operations further include determining whether to signal information indicating that the transmission of the ICF is permitted to be omitted in performing a channel access via the NPCA primary channel or to signal information indicating that the transmission of the ICF is not permitted to be omitted in performing a channel access via the NPCA primary channel, based on at least one of communication quality between the communication apparatus and another communication apparatus, an amount of information to be transmitted by the communication apparatus, and a state of the communication apparatus.

11. The communication apparatus according to claim 10, wherein the communication quality is a received signal strength indication (RSSI) or a signal-to-noise ratio (SNR).

12. The communication apparatus according to claim 10, wherein the state of the communication apparatus includes a processing load of the communication apparatus, an operation mode in which the communication apparatus is operating, and a battery state of the communication apparatus.

13. The communication apparatus according to claim 10, wherein the operation mode includes a power save mode, an enhanced multi-link single radio (EMLSR) mode, and an enhanced multi-link multi ratio (EMLMR) mode.

14. A control method of a communication apparatus configured to perform communication compliant with an IEEE 802.11 series standard, the control method comprising:
externally signaling information indicating whether transmission of an ICF is permitted to be omitted when channel access is performed via an NPCA primary channel to be used in a case where a BSS primary channel is unavailable; and
after the signaling, communicating a frame different from the ICF with another communication apparatus via the NPCA primary channel.

15. A control method of a communication apparatus configured to perform communication compliant with an IEEE 802.11 series standard, the control method comprising:
receiving signaling including information indicating whether transmission of an ICF is permitted to be omitted when channel access is performed via an NPCA primary channel to be used in a case where a BSS primary channel is unavailable; and
after the signaling is received, communicating a frame different from the ICF with another communication apparatus via the NPCA primary channel.

16. A communication apparatus configured to perform communication compliant with an Institute of Electrical and Electronics Engineers (IEEE) 802.11 series standard, the communication apparatus having a Non-Primary Channel Access (NPCA) function for communicating via an NPCA primary channel when a primary channel of a basic service set (BSS) is unavailable, the communication apparatus comprising:
at least one memory that stores a set of instructions; and
at least one processor that executes the instructions, the instructions, when executed, causing the communication apparatus to perform operations including:
storing, in a storage area, information relating to an omission condition for an initial control frame (ICF) in a case where an NPCA function is used; and
controlling the communication apparatus to transmit a frame to another communication apparatus without transmitting the ICF, based at least on a determination that the omission condition is satisfied based on the information stored in the storage area.

17. The communication apparatus according to claim 16, wherein the communication apparatus is station and the other communication apparatus is access point.
